(19) United States
(12) Patent Application Publication
(10) Pub. No.: US 2019/0174250 A1
(43) Pub. Date: Jun. 6, 2019

(54) Communications Tool For Requesting, Tracking, And/Or Managing Services

(71) Applicant: Innovative Monkey Technologies, Inc., Maple Grove, MN (US)

(72) Inventor: Peter Stangas, Maple Grove, MN (US)

(21) Appl. No.: 16/177,509

(22) Filed: Nov. 1, 2018

Related U.S. Application Data
(63) Continuation of application No. 15/638,566, filed on Jun. 30, 2017, now abandoned.
Application No. 15/638,566 is a continuation of application No. 14/275,282, filed on May 12, 2014, now abandoned.
(60) Provisional application No. 61/821,957, filed on May 10, 2013.

(51) Int. Cl. H04W 4/00; H04M 1/725; G06Q 10/00

(52) U.S. Cl. CPC H04W 4/00; H04L 67/34; G06Q 10/20; H04M 1/72522

(57) ABSTRACT

A method for receiving a request for a service and for providing services based on the request. The method may include providing an interface module configured for downloading to an electronic mobile device as a mobile app and configured for display on a display screen of the electronic mobile device, and receiving, via the interface module, information relating to a request for a service, the information including at least one of written text, a photo, a video, and an audio file. Upon activation by a user, the information relating to the request may be transmitted to a remotely located backend module. The transmitted information relating to the request may be analyzed for determining how to complete the requested service.

### FIELD OF THE INVENTION

The present disclosure relates to a communications tool for requesting, tracking, and/or managing services. Particularly, the present disclosure relates to a communications tool for requesting, tracking, and/or managing services, such as repair or maintenance requests and services. More particularly, the present disclosure relates to a mobile communications “app” for requesting, tracking, and/or managing such services.

### BACKGROUND OF THE INVENTION

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

In a variety of service industries, such as the repair or maintenance industries and property management industry, one concern is how to provide such services efficiently and cost-effectively. This concern is magnified when the services are being provided with respect to a substantial number of locations and/or to a substantial number of end consumers or customers. There are a variety of conventional manners in which such consumers may request service, typically involving contacting a service provider, meeting with the service provider or otherwise a contractor or representative of the service provider at the location of service to discuss the details of the services needed, and receiving a proposal for the cost of the service upon which the consumer can make a decision. Such conventional manners of requesting services, however, has drawbacks in efficiency, thereby driving up costs for the service.

Thus, there is a need in the art for improved communications tools for requesting, tracking, and/or managing services, such as but not limited to, repair or maintenance requests and services or other services relating to, for example, property management. More particularly, there is a need for a mobile communications “app” for requesting, tracking, and/or managing such services, which can generally increase efficiencies for service providers, thereby lowering costs.

Brief Summary of the Invention

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In general, the various embodiments of the present disclosure may permit a user to make requests for service or estimate for service, such as but not limited to, requests for repair, maintenance, or restocking, or estimates therefor, through a mobile device, and specifically via a web-based application or mobile app. The application or app may permit the user of the mobile device to provide and send a description or other details or information relating to the request for services to a service provider in an efficient manner, and which may include photographs, videos, and/or audio relating to the requested services. The mobile device may communicate over a network, such as but not limited to, a telephone network, wireless network, LAN, or WAN, such as the Internet, with a backend module, to which the request and related information may be delivered and reviewed, automatically or manually, to determine what the request for service entails. Appropriate resources can be deployed or diverted to the location whereat the services are to be performed, depending on, for example, the urgency of the request. The application or app may permit a user of the mobile device to track and/or manage various aspects of overall service performed per the request, such as but not limited to, status, invoicing, service technician information, etc.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram of the application interacting with a consumer device, backend module, network, and database(s), according to an embodiment of the present disclosure.

FIG. 2A is an example screenshot of a user interface showing a log-in screen, according to an embodiment of the present disclosure.

FIG. 2B is an example screenshot of a user interface showing a change of password option, according to an embodiment of the present disclosure.

FIG. 3 is an example screenshot of a user interface showing a consumer information submission interface, according to an embodiment of the present disclosure.

FIG. 4A is an example screenshot of a user interface showing a photograph submission interface, according to an embodiment of the present disclosure.

FIG. 4B is an example screenshot of a user interface showing a text submission interface, according to an embodiment of the present disclosure.

FIG. 4C is an example screenshot of a user interface showing an urgency identifier interface, according to an embodiment of the present disclosure.

FIG. 5 is an example screenshot of a user interface showing an email setup interface, according to an embodiment of the present disclosure.

FIG. 6 is an example screenshot of a user interface showing an email interface, according to an embodiment of the present disclosure.

FIG. 7 is an example screenshot of a user interface showing a general settings interface, according to an embodiment of the present disclosure.

FIG. 8A is an example screenshot of a user interface showing a maintenance log, according to an embodiment of the present disclosure.

FIG. 8B is an example screenshot of a user interface showing an individual service request log, according to an embodiment of the present disclosure.

FIG. 8C is an example screenshot of a user interface showing a maintenance log, according to an embodiment of the present disclosure.

FIG. 8D is an example screenshot of a user interface showing a maintenance log, according to an embodiment of the present disclosure.

FIG. 9 is a flow chart of a method of use of an embodiment of the present disclosure.

### DETAILED DESCRIPTION

The present disclosure relates to novel and advantageous communications tools for requesting, tracking, and/or managing services. Particularly, the present disclosure relates to novel and advantageous communications tools for requesting, tracking, and/or managing services, such as but not limited to, repair or maintenance requests and services or other services relating to, for example, property management. More particularly, the present disclosure relates to a mobile communications “app” for requesting, tracking, and/or managing such services, which can generally increase efficiencies for service providers, thereby lowering costs.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

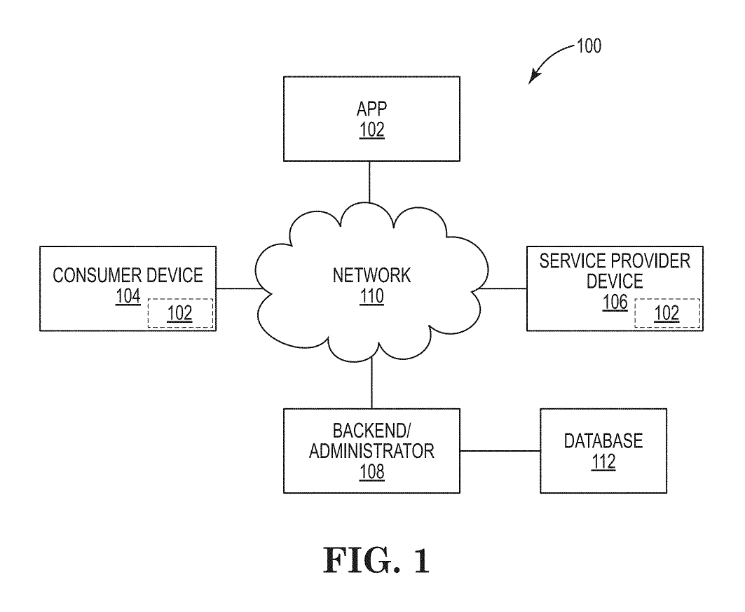

Generally, the various embodiments of the present disclosure may permit a user to make requests for service or an estimate for service (often collectively referred to herein as simply a “request for service” for ease of explanation), such as but not limited to, requests for repair, maintenance, or restocking, or estimates therefor, through a mobile device, and specifically via a web-based application or stand-alone mobile application, commonly referred to as a mobile “app.” Referring to FIG. 1, in one embodiment a Service Requesting System 100 may facilitate a service request between a consumer, using, for example, a mobile device 104, and a service provider via, for example, another computing or mobile device 106. It is understood, however, that any device may be used to access the system. The Application or app 102 may permit the user of the mobile device 104 to provide and send a description or other details or information relating to the request for services to a service provider's device 106 in an efficient manner. The app 102 may be an application accessible over network 110 and/or may be, or a portion thereof may be, resident on the consumer 104 and/or service provider devices 106. In some embodiments, as will be discussed in more detail below, the details of the service requested may include photographs, videos, and/or audio relating to the requested services. The mobile devices 104 and 106 may communicate over a network 110, such as but not limited to, a telephone network, wireless network, LAN, or WAN, such as the Internet, with a backend module 108, to which the request and related information may be delivered and reviewed, automatically or manually, to determine what the request for service entails. The backend module 108 may be remotely located with respect to the devices 104 and 106. A database 112 may be connected to the backend module 108 or exist within the “cloud.” In some embodiments, the consumer's mobile device 104, service provider's device 106 and backend module 108 may be owned and/or operated by the same entity while in other embodiments, they may be owned and/or operated by different entities. In some embodiments, appropriate resources can be deployed or diverted to the location whereat the services are to be performed, depending on, for example, the urgency of the request. In still further embodiments, the application or app 102 may permit a user of the mobile device 104, 106 or backend module to track and/or manage various aspects of overall service performed per the request, such as but not limited to, status, invoicing, service technician information, etc.

In order to accomplish the above, the various embodiments of the present invention may employ one or more modules or interfaces for requesting, tracking, and/or managing services. The various example modules or interfaces for a system for requesting, tracking, and/or managing services may be provided as hardware and/or software components, and in one embodiment may be provided as a web-based application or a mobile app. Certain modules or interfaces may be configured for use with generally any electronic or other processing device, and may particularly be configured for access from, or download and use from, a mobile device, such as but not limited to a smartphone, tablet device, and the like, in conventional manners, such as by access through a web browser or by download and install from an “app store.” The modules or interfaces of the system, in some embodiments, may be configured and/or branded specifically to a particular service provider, and as such may be used as a communications tool for communications with only that particular service provider and contractors or representatives thereof. In other embodiments, however, the modules or interfaces of the system could be generic or generically branded and configured instead to permit service requests and other communications to and/or with a plurality of related or unrelated service providers, which may opt for participation, subscription, or registration with the system.

In general, upon running into a need or desire for a particular service, a consumer may initially access and utilize the system to initiate a request for service. The service desired or requested may relate to any type of service, and is not limited to any service example provided herein. In some embodiments, the type of service desired or requested may be a request for repair(s), cleaning, or other maintenance, for restocking inventory or other inventory services, or any other property management or store management service(s). As described above, in one embodiment, the consumer may access the system to initiate a request for service via a web-based application or a mobile app operating on a mobile device. In this regard, the consumer may request service in any location in the presence of a communications network, such as but not limited to a telephone network, wireless network, LAN, or WAN, such as the Internet.

Upon accessing the communications system, such as via a mobile app, in one embodiment, the consumer may be presented with a landing interface or welcome interface that indicates the consumer has successfully connected with the communications system. An example landing interface may include an application splash screen or main menu, among any other useful information, such as but not limited to, instructions on how to use the system or mobile app, or an icon or menu item selectable for accessing such instructions. In another embodiment, a landing interface may include, or provide a selectable icon or menu item for directing the consumer to, a form or other interface for initiating a request for service, referred to herein as a request interface.

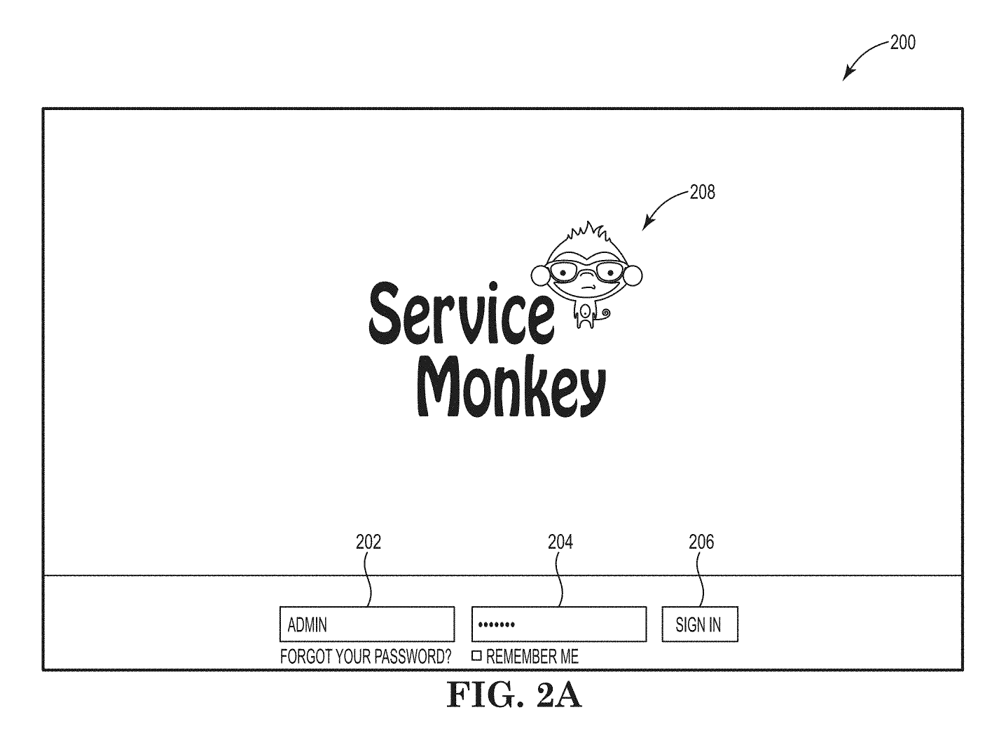

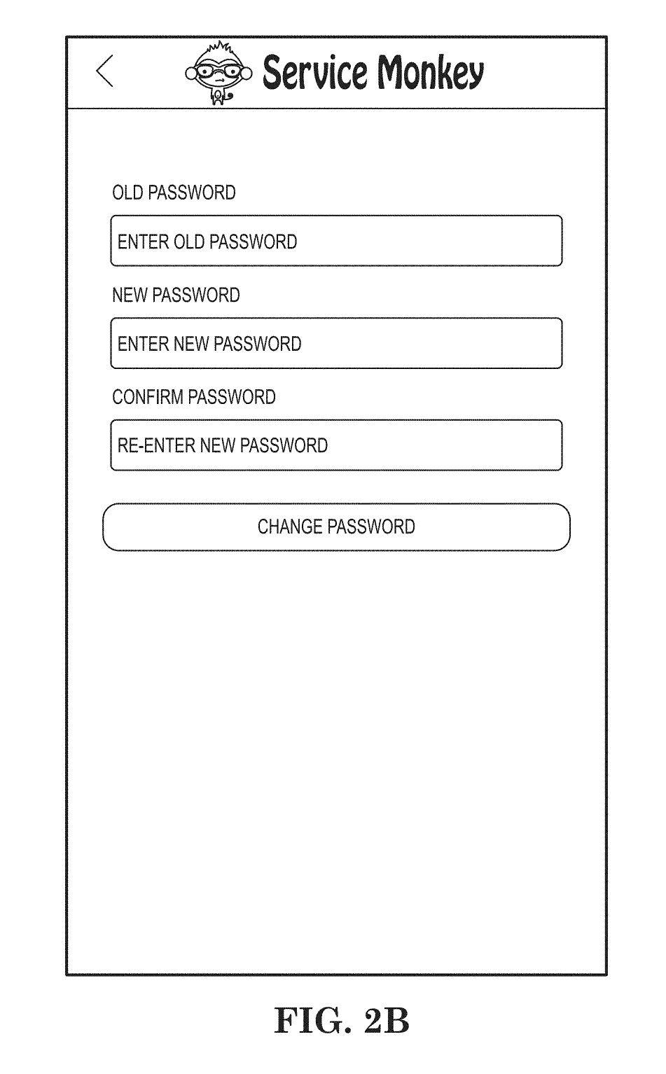

In some embodiments, either during an initial use or setup of the system and/or during any subsequent session, the consumer may be required to provide a specified amount of consumer information relating to the consumer and/or to the entity for which the consumer is employed and/or the consumer may be required to provide log-in information. For example, FIG. 2A shows a log-in interface 200 requiring a username 202 and password 204 before a user may sign in 206. The log-in interface 200 may also display a company logo 208, which may, in further embodiments, be customized for each corporate user, for example. A user may also request a new password or change their password, using an interface such as that shown in FIG. 2B. In some embodiments, the landing interface or some additional consumer information submission interface may be configured to receive any required consumer information desired or required by the system or specific service provider in order to, for example, identify the consumer requesting the service. Consumer information may comprise any information that identifies or is associated with a particular consumer.

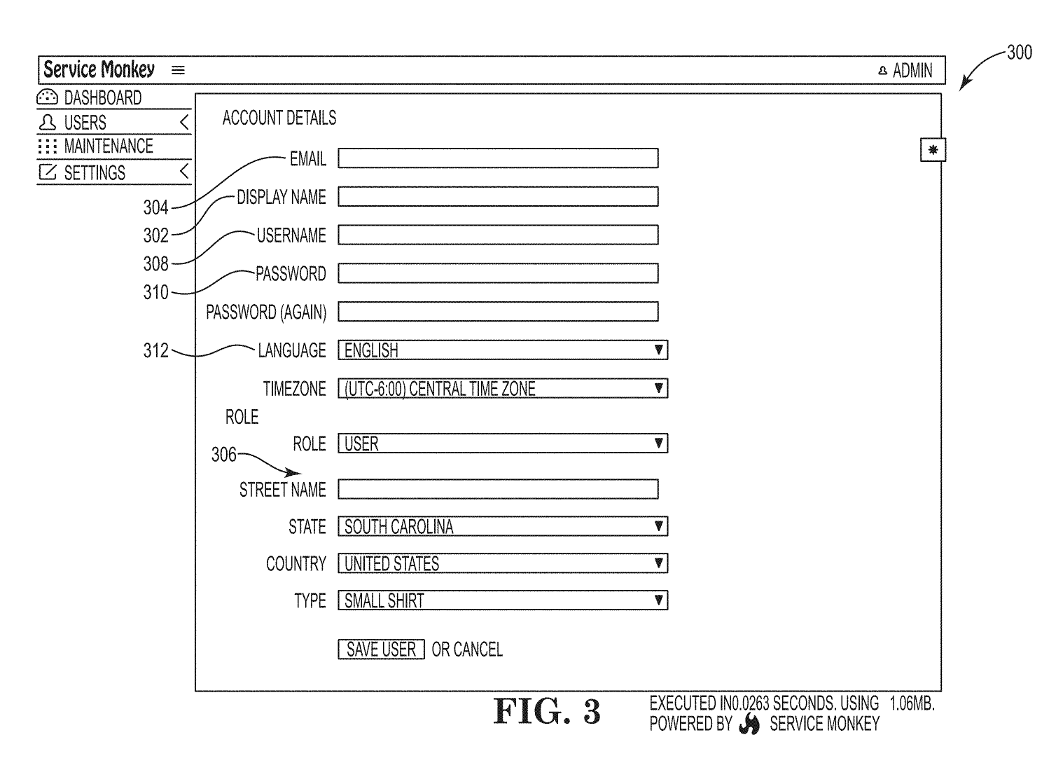

Referencing FIG. 3, for example, a consumer information submission interface 300, which may be accessible from the consumer device and/or backend module, may be used to add or modify consumer information including, the consumer's name 302, e-mail address 304, address 306, desired username 308, desired password 310, language 312, or any other relevant information. Other consumer information may include, but is not limited to, phone number, employer, information relating to the employer, employee identification number, job title, etc. The landing interface or other consumer information submission interface may provide any suitable number of data entry fields by which the consumer may provide such information, as will be understood by those skilled in the art. The data entry fields may include any suitable style of data entry field, such as but not limited to, text fields, drop-down selection boxes, radio buttons, etc. As generally indicated above, in some embodiments, after a first time such information is requested and entered by the consumer, or, for example, after such information is entered as part of and during an initial registration of the system, such information, or portions thereof, may be saved for future use. In such embodiments, the consumer may not be required to repeatedly submit consumer information for each request for service, as the system will already have the information available. Thus, in some embodiments, after such consumer information is saved by the system, the landing interface or other consumer information submission interface may be bypassed or may otherwise omit any request for such consumer information. In still further embodiments, the system may save and store consumer information for multiple users. Such saved consumer information, or any portion thereof, may be automatically associated with any request for service or estimate for service submitted by that consumer.

In other embodiments, the consumer may be pre-registered with the system, and thus any required information may have been previously obtained and configured with the system prior to initial use by the consumer. In still other embodiments, information about the consumer and/or log-in information may not be required at all to simply access the system. However, in such embodiments, the consumer may be required to provide any such necessary information for identifying the consumer and/or the entity for which the consumer is employed during submission of a first request for service, after which the data may be saved for future use, or the consumer may be required to provide such information during each submission of a request for service if all or portions of the consumer information are not saved.

A request interface may be a single module or interface or a combination of modules or interfaces permitting a consumer to initiate a request for service. In one embodiment, the request interface may permit the requesting consumer to complete a request for service or an estimate for service electronically or digitally, such as via the internet, mobile network, or other network. Generally, the request interface provides an interface through which the requesting consumer may enter information relating to the type of service or estimate for service requested. Such information may include any information that might be deemed by the receiving service provider or the requesting consumer as necessary or desirable information, and may indeed change from service provider to service provider or even from consumer to consumer. In one embodiment, the information relating to the service or estimate requested may include any, but not necessarily all, of the following: information about the requesting consumer or the entity for which the requesting consumer is employed; the work to be completed; the physical and/or geographical location of the work; the urgency of the request; whether the request is for service or for an estimate for the service; etc.

The request interface may permit the consumer to enter information pertaining to the request for service in one or more of a variety of formats, such as but not limited to, text entry, drop-down menus or other pre-filled selection modes, photographs, videos, audio clips, or any other suitable format now known or developed in the future, and any combination of formats. For example, in one embodiment, the consumer may desire to provide one or more photographs of the problem for which the service is requested in order to illustrate to the service provider the exact problem to be addressed. For example, and example only, the consumer may take a picture of a broken water line requiring repair, a front entrance of a building where an automobile crashed into and requiring repair and rebuilding, a hotel room or a portion(s) thereof that has been damaged and/or needs a particular type of cleaning, a broken refrigerant line that requires repair and clean-up of the surrounding area. Of course, these are just a small fraction of the types of service that may be needed or desired, and the various embodiments of the present disclosure are not to be limited by the examples provided.

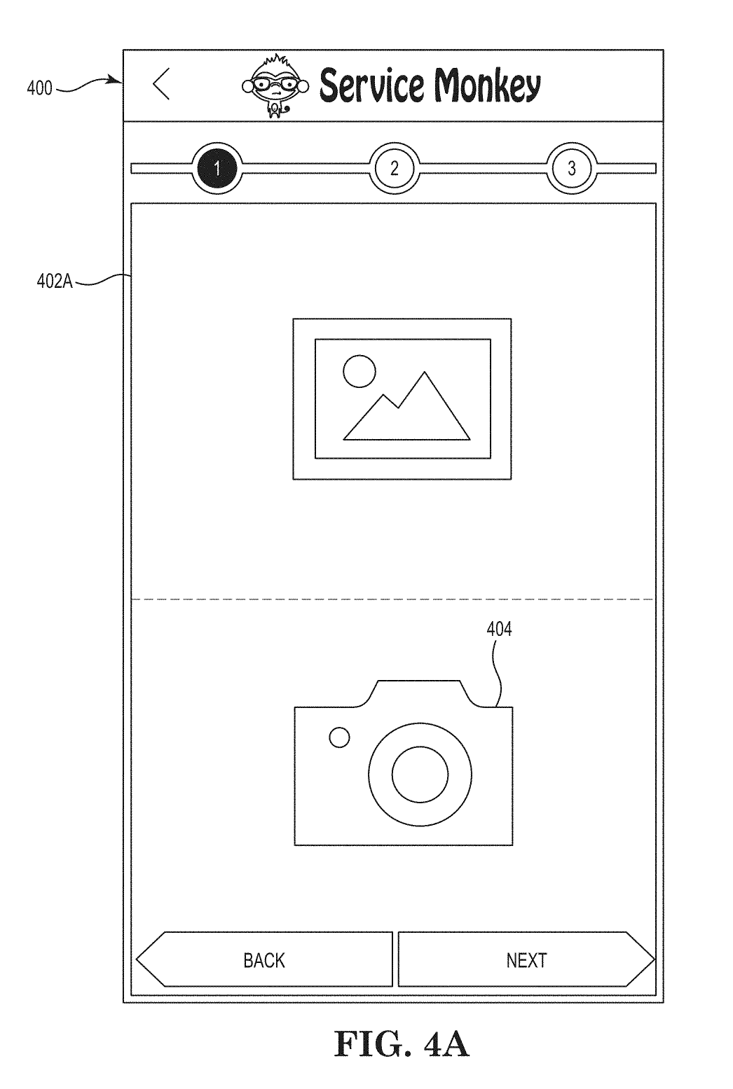

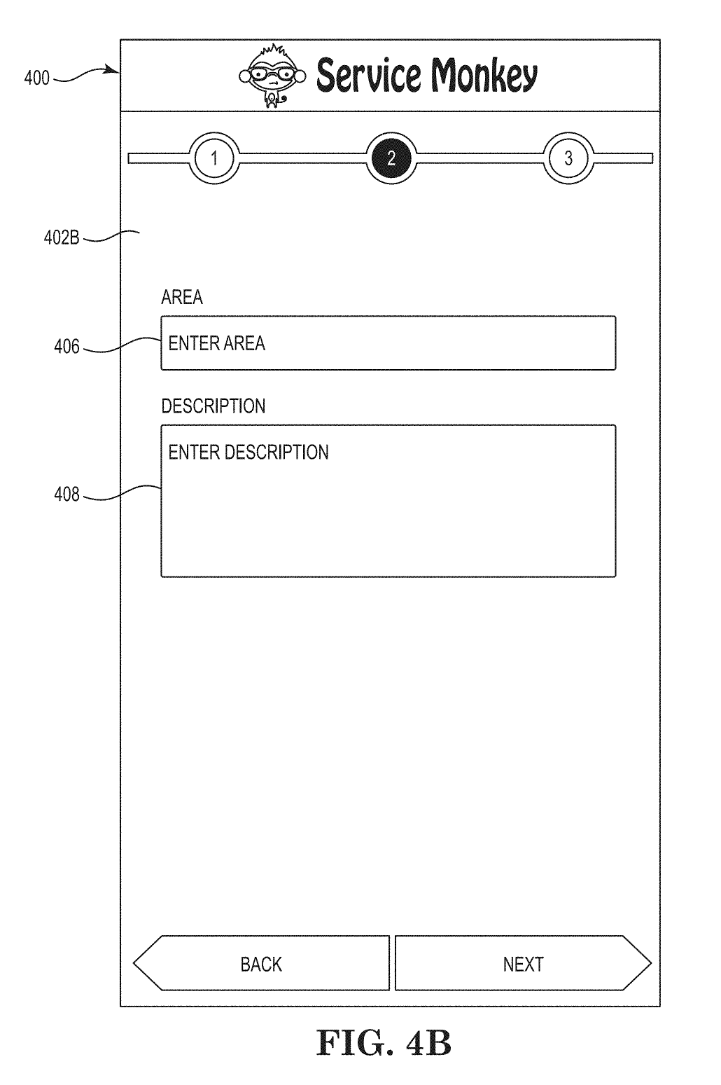

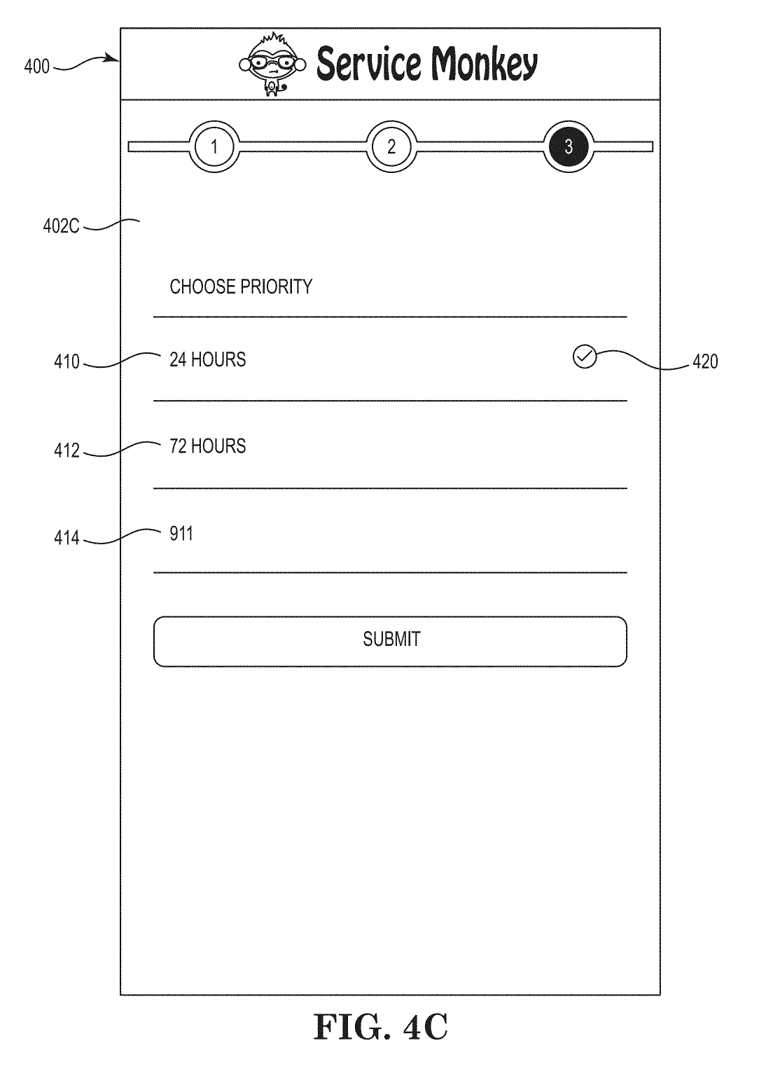

In one particular embodiment seen in FIG. 4A, a request interface 400 may include, or provide a photograph submission interface 402A with a selectable icon 404 or menu item which may provide the consumer with the ability to upload and submit digital photographs. As will be recognized by those skilled in the art, a consumer can obtain digital photographs by any suitable number of ways, including but not limited to, scanning the photograph, uploading the photograph from a known source, or simply taking the picture at the time of the request, such as via a mobile device. The photograph submission interface may provide the consumer with data submission fields whereby the consumer can upload and submit digital photographs. However, in another embodiment, the photograph submission interface may permit the consumer to take in-app pictures, thereby avoiding additional steps relating to the searching and uploading processes required for existing photographs. In this regard, the photograph submission interface may include a selectable user interface button or icon for taking one or more pictures, such as one or more pictures of the to-be-serviced area(s), item(s), device(s), etc. At any rate, the consumer may take some action at the photograph submission interface, such as but not limited to, the actuation of a user interface button or other actuation device in order to bring the consumer to a camera or photo interface, similar to typical camera or photo interfaces on smartphones and tablets, whereby the user can aim their electronic device toward the to-be-serviced area(s), item(s), device(s), etc., as desired, and take a picture thereof. In one embodiment, the photo may not be stored on the user's actual device. Rather, in one embodiment, in-app pictures may be taken and transmitted through the system without being stored to the user devices nonvolatile memory, for example.

Upon taking one or more pictures of the to-be-serviced area(s), item(s), device(s), etc., the photograph submission interface may display the picture(s), or thumbnail(s) of the picture(s), taken for the user to review prior to acceptance and/or submission. The consumer may also have the ability to reshoot any photo, if desired. In some embodiments, the system may have software configured for assessing the quality of the pictures, and as such, the system may further require the consumer to reshoot a photo if the quality is below a certain threshold.

As seen in FIG. 4B, the request interface 400 may additionally or alternatively include, or provide a selectable icon or menu item for directing the consumer to, a text submission interface 402B, which may provide the consumer with the ability to submit a written description 408 of the service needed or desired, a written description of, or relating to, any corresponding uploaded photo or photo taken with an in-app camera, and/or written details of anything else relating to the service needed or desired, such as the general area to service 406. The text submission interface may utilize any method for inputting text, such as via a text input box, pre-filled drop down menus, or the like. In some embodiments, the text submission interface may utilize voice-to-text hardware and/or software to receive audio or voice input and convert the audio or voice input into text.

In some embodiments, the system may permit only a picture or a written description to be submitted by the consumer with the request for service. However, in other embodiments, the system may permit any combination of one or more pictures and one or more written descriptions, as may be necessary or desirable for the user to provide sufficient information to illustrate and/or describe the service needed, desired, or otherwise being requested. In still further embodiments, the request interface may be configured to additionally or alternatively accept other forms of information, and the various embodiments of the present disclosure are not limited simply to photographs and text submissions.

For example, in one embodiment, the request interface may additionally or alternatively include, or provide a selectable icon or menu item for directing the consumer to, an audio submission interface, which may provide the consumer with the ability to submit an audio description of the service needed or desired, an audio description of, or relating to, any corresponding uploaded photo or photo taken with an in-app camera, and/or audio details of anything else relating to the service needed or desired. As will be recognized by those skilled in the art, a consumer can obtain an audio file having such audio descriptions by any suitable number of ways, including but not limited to, uploading a previously recorded audio file from a known source or simply recording audio at the time of the request, such as via a mobile device. The audio submission interface may provide the consumer with data submission fields whereby the consumer can upload and submit audio files. However, in another embodiment, the audio submission interface may permit the consumer to record audio directly into the audio submission interface, thereby avoiding additional steps relating to the searching and uploading processes required for existing audio files. In this regard, the audio submission interface may include a selectable user interface button or icon for taking recording one or more audio descriptions or files, such as one or more audio descriptions of the to-be-serviced area(s), item(s), device(s), etc., an audio description of, or relating to, any corresponding uploaded photo or photo taken with an in-app camera, and/or audio details of anything else relating to the service needed or desired. At any rate, the consumer may take some action at the audio submission interface, such as but not limited to, the actuation of a user interface button or other actuation device in order to bring the consumer to a recording interface, similar to typical audio recording interfaces on smartphones and tablets, whereby the user can record suitable audio. Like in-app pictures, in some embodiments, in-app audio recordings may be recorded and transmitted without being stored on the user devices nonvolatile memory, for example.

Likewise, in one embodiment, the request interface may additionally or alternatively include, or provide a selectable icon or menu item for directing the consumer to, a video submission interface, which may provide the consumer with the ability to upload and submit one or more videos. As will be recognized by those skilled in the art, a consumer can obtain videos or video files by any suitable number of ways, including but not limited to, uploading the video from a known source or simply recording the video at the time of the request, such as via a mobile device. The video submission interface may provide the consumer with data submission fields whereby the consumer can upload and submit one or more video files. However, in another embodiment, the video submission interface may permit the consumer to take in-app videos, thereby avoiding additional steps relating to the searching and uploading processes required for existing video files. In this regard, the video submission interface may include a selectable user interface button or icon for recording one or more videos, such as one or more videos of the to-be-serviced area(s), item(s), device(s), etc. At any rate, the consumer may take some action at the video submission interface, such as but not limited to, the actuation of a user interface button or other actuation device in order to bring the consumer to a video camera or video interface, similar to typical video camera or video interfaces on smartphones and tablets, whereby the user can aim their electronic device toward the to-be-serviced area(s), item(s), device(s), etc., as desired, and record a video thereof. Like in-app pictures and audio, in some embodiment, in-app video may be recorded and transmitted without being stored on the user devices nonvolatile memory, for example. As will be appreciated, video files can often also include audio, and as such, submitting a video with a request for service also provides the consumer with the ability to submit, as part of the video file, an audio description of the service needed or desired, a narration to the video, and/or audio details of anything else relating to the service needed or desired. In this regard, a video submission can generally, but is not required to, act as an alternative to photograph(s) and/or written description(s), discussed above.

While various forms or formats by which information relating to the service needed or desired can be submitted with a request for service, it is understood that the various embodiments of the present disclosure may be configured to accept any other suitable form or format of information now known or later developed.

The request interface, in some embodiments, may additionally include, or provide a selectable icon or menu item for directing the consumer to, a location submission interface, which may provide the consumer with the ability to submit a written description or other input, such as audio, of the location whereat the service is needed or desired. The location submission interface may utilize any method for inputting text, such as via a text input box, pre-filled drop down menus, or the like, or any method for receiving other suitable input relating to the location, such as audio input. In some embodiments, the method for inputting text may utilize voice-to-text hardware and/or software to receive audio or voice input and convert the audio or voice input into text.

In other embodiments, however, the system may include a location identifier module that, generally, may automatically determine the location, or an approximation of the location, of a mobile device on which the system is running or through which a request for service is being made. The location identifier module may utilize any method for determining location, such as but not limited to, IP addressing techniques, triangulation, multilateration, or utilizing any suitable local or global positioning systems. In some embodiments, the location identifier module may utilize existing capabilities of a mobile device, such as a smartphone, for determining location information relating to the mobile device. The location identifier module may automatically associate any available location information, or any portion thereof, with a request for service. In one embodiment, such location information associated with a request for service, or any portion thereof, may be displayed to the consumer. The information may be displayed in any format. However, in one embodiment, the information may be displayed by indicating the position of the consumer on a visual, and in some cases interactive, map. In various embodiments, a user may confirm an automatically determined location before submission. This may be particularly useful when the service request is submitted at a location other than the requested service site.

In one embodiment, the system may use a location identifier module that uses a Bluetooth location technology, such as Apple Inc.'s iBeacon. A Bluetooth transponder may be placed at the exact location where service is requested. The service provider may then be directed to the location and alerted when he is in sufficient proximity to the project. In another embodiment, as one in the art may appreciate, the user (such as a hotel manager) may turn their phone into an iBeacon, thereby directing the service provider upon arrival directly to the manager. The manager and service provider may both be alerted when they enter a pre-determined proximity of each other and may be presented with identifying information to recognize each other. In this regard, the application may quickly facilitate access of the service provider to restricted areas that need service.

As seen in FIG. 4C, the request interface 400 may additionally include, or provide a selectable icon or menu item for directing the consumer to, an urgency identifier interface 402C, which may provide the consumer with the ability to submit an indication 420 of the type 410, 412, 414 and/or urgency of the service needed or desired. In one embodiment, for example, the urgency identifier interface may permit the consumer to identify whether the request for service is a request for the service to be completed (e.g., without needing an estimate first) or a request for an estimate for the service. Likewise, in one embodiment, for example, the urgency identifier interface may permit the consumer to identify some period of time in which it is desired that the service be completed, or at least started, or by which the estimate for the service is to be received. While any suitable identifying time period may be utilized, in one embodiment, pre-determined time periods may be provided to the consumer via the urgency identifier interface from which the consumer may select, such as but not limited to: a first time period expressing that the request is an emergency 414 and should be handled as soon as possible; a second time period 410, 412 expressing that a quick turn-around is desired, but that it is not an emergency (e.g., a 24 hour (410), 48 hour, or 72 hour (412) quick-turnaround service call); or any other suitable pre-determined time period that may be offered by a given service provider or that may be particularly requested by, and configured for, a particular consumer. The urgency identifier interface may utilize any method for receiving such information from the consumer, such as via a text input box, pre-filled drop down menus, radio buttons, or the like. In some embodiments, the urgency identifier interface may utilize voice-to-text hardware and/or software to receive audio or voice input and convert the audio or voice input into text.

While discussed as separate modules or interfaces herein, it is recognized that in other embodiments, the landing interface and the request interface, as well as any other interfaces described herein, in any combination, may be combined as a single interface or multiple interfaces in different configurations than described herein. The request interface, or any other interface described herein, of the system may also include any other desirable information. For example, one or more of the interfaces may include additional information relating to the registrant of the system, the version of the app or other related software information, the system developer, instructions on how to use the system, etc. or one or more icons or menu items selectable for accessing such information. Likewise, one or more of the interfaces may request information from the consumer other than that described above, and such requested information may vary from service provider to service provider and/or from consumer to consumer.

Once the consumer has entered (or the system has automatically entered on the consumer's behalf) the required consumer and/or request information, such as any photos, written descriptions, audio files, and/or video files, the consumer may take some action at the request interface, such as but not limited to, the actuation of a user interface button or other actuation device, in order to submit the electronic or digital request for service to a service provider. In some embodiments, the consumer may be redirected to a submission confirmation interface where the consumer may be provided with a confirmation that the request for service has been submitted and any other suitable information or details as desired by the receiving service provider, such as but not limited to, information relating to a time frame for when the consumer can expect the service to be completed and/or to receive an estimate for the service, contact information for the service provider, agreement terms relating to the service or estimate, etc. The submission confirmation interface may present a list reconfirming presently and previously entered information by the consumer. As with the other interfaces, the submission confirmation interface may also include any other desirable information relating to the request for service.

In additional embodiments, the system may associate a unique tracking identifier for the request for service, enabling easy and efficient identification of matters relating to the request for service and/or the performance of the service. Such unique tracking identifier may be provided in any suitable form, including but not limited to a unique identifying number or alphanumeric sequence, a scannable bar code, including two-dimensional and three-dimensional bar codes, etc. In some embodiments, the unique tracking identifier may be provided by the service provider. In other embodiments, the system may automatically generate and assign the unique tracking identifier to the request for service. The unique tracking identifier may be displayed to the consumer, for example, at the submission confirmation interface.

Upon, or subsequent to, submission of a request for service or estimate for service (again often being collectively referred to herein simply as a “request for service” or the like for convenience of explanation), the request may be transmitted to a designated service provider. The service provider may have or employ a “backend” module of the system comprised of hardware and/or software components, as described in detail above, configured to receive the electronically submitted and transmitted request for service, parse the request, and output the request in a suitable format, such as but not limited to, a digital or electronic file which may be further utilized by the backend module, a file or image for display on a display device for review by the service provider, a print-out for review by the service provider, or any other suitable format or combination of formats.

As stated above, the system, and modules or interfaces thereof, in some embodiments, may be configured and/or branded specifically to a particular user, user company, or service provider, and as such all requests made via the branded system will be transmitted to that particular user, user company, or service provider. In other embodiments, however, the system, and modules or interfaces thereof, could be generic or generically branded and configured instead to permit service requests and other communications with a plurality of related or unrelated service providers, which may opt for participation, subscription, or registration with the system. In such embodiments, the request interface, described above, may additionally include, or provide a selectable icon or menu item for directing the consumer to, a provider identifier interface, which may provide the consumer with the ability to indicate, potentially from a list of possible service providers, the service provider to which the request is to be submitted. The provider identifier interface may utilize any method for receiving a provider selection from the consumer, such as via a text input box, pre-filled drop down menus, radio buttons, or the like. In some embodiments, the provider identifier interface may utilize voice-to-text hardware and/or software to receive audio or voice input and convert the audio or voice input into text.

Nevertheless, in some embodiments, upon, or subsequent to, receipt of the request for service and accompanying information, the receiving service provider may provide a confirmation to the consumer of receipt of the request for service. In some embodiments, the confirmation may be provided to the consumer in substantially “real-time.” The confirmation may include any suitable information or details as desired by the receiving service provider, such as but not limited to, information relating to a time frame for when the consumer can expect the service to be completed and/or to receive an estimate for the service, contact information for the service provider, agreement terms relating to the service or estimate, further information (photos, descriptions, etc.) requested to be submitted in order to accurately perform an estimate or prepare, etc. In some embodiments, the confirmation provided by the receiving service provider may be generated automatically, for example by the system on behalf of the service provider, while in other embodiments, the confirmation may be manually prepared and/or particularly tailored for a particular consumer's request. In still further embodiments, the confirmation generated and transmitted to the consumer may be, but need not be, the same confirmation received by the consumer at the submission confirmation interface. Confirmation may alternatively or additionally be generated by the service provider submitting a photo, description, video, or audio file indicating the completion of the service requested.

Also upon, or subsequent to, receipt of the request for service, the receiving service provider may comply with the request by generally performing the service and/or providing an estimate for service, whichever may be the case. An advantage of the various embodiments of the present disclosure over conventional methods of receiving requests for service is that a substantial or significant amount, if not all, of the information relating to the service needed or desired by the consumer can be received with the initial request for service without requiring participation of the service provider, or a contractor or representative thereof. That is, the service provider, or a contractor or representative thereof, need not visit the location where the services are to be completed in order to identify the scope of the work and, for example, what work needs to be completed and/or which service provider employees or subcontracting service providers might be necessary. Rather, this information is beneficially provided with, or deducible from, the information received from the consumer with the request for service.

In one embodiment, the backend module of the system may automatically analyze the received and/or parsed information of the request for service and determine the appropriate work to be performed and/or the service provider representative(s) or contractor(s) needed and may forward the information, along with any additional information that may be deemed suitable by the backend module and/or the service provider, to the identified service provider representative(s) or contractor(s). In some embodiments, the hardware and/or software components of the backend module may include image processing hardware and/or software components to assist in analyzing of any photos and videos of the submitted request for service. Automatically analyzing requests for service may, however, be done in any manner known in the art, and no particular method of analyzing is particular to the system and method of the present disclosure. In another embodiment, the service provider, or a representative or contractor thereof, may manually analyze the request for service to determine, possibly among other things, the appropriate work to be performed and/or the service provider representative(s) or contractor(s) needed and may forward the information, along with any additional information that may be deemed suitable by the service provider, to the identified service provider representative(s) or contractor(s).

In further embodiments of the present disclosure, the system may be configured, through any of the modules or interfaces described above or additional modules or interfaces or any combination thereof, to facilitate and enable communication between the consumer and service provider, or any representatives thereof, throughout the service, for example, from the time of submission of the request to final completion of, and/or payment for, the service. In this regard, all communication may be handled via the system, which can be particularly beneficial in embodiments where the consumer is accessing the system via a web-based application or mobile app on a mobile device. Specifically, the system can enable substantially “real-time” communication between the consumer and service provider at all times throughout the service, even where the consumer and service provider are remotely located.

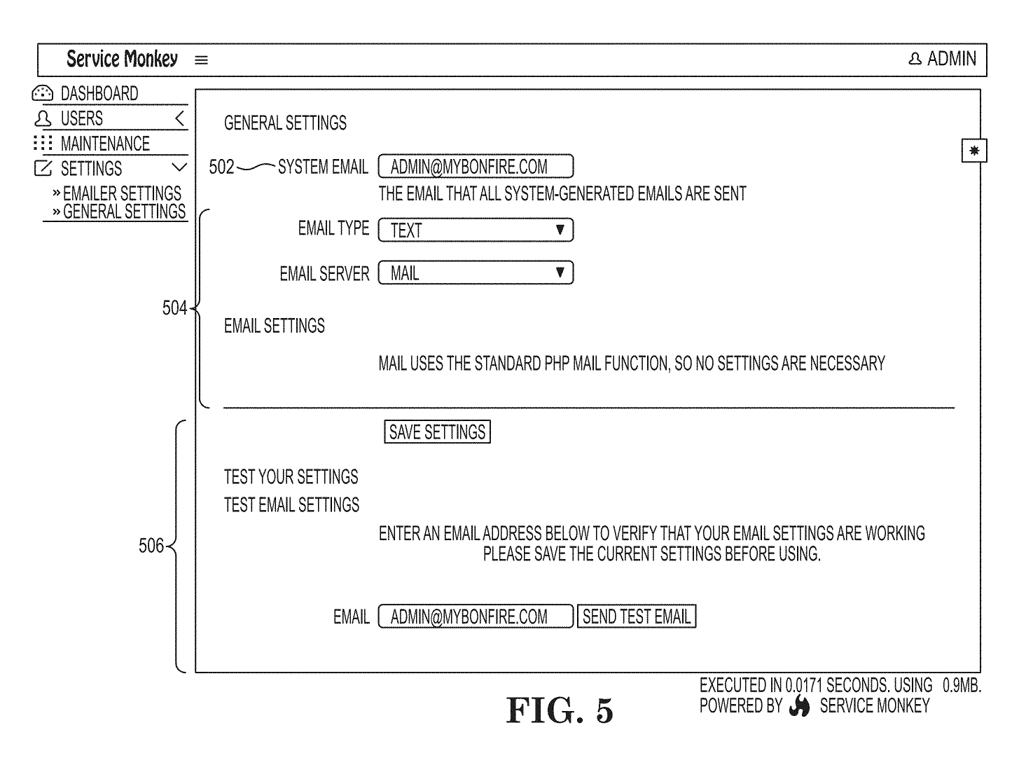

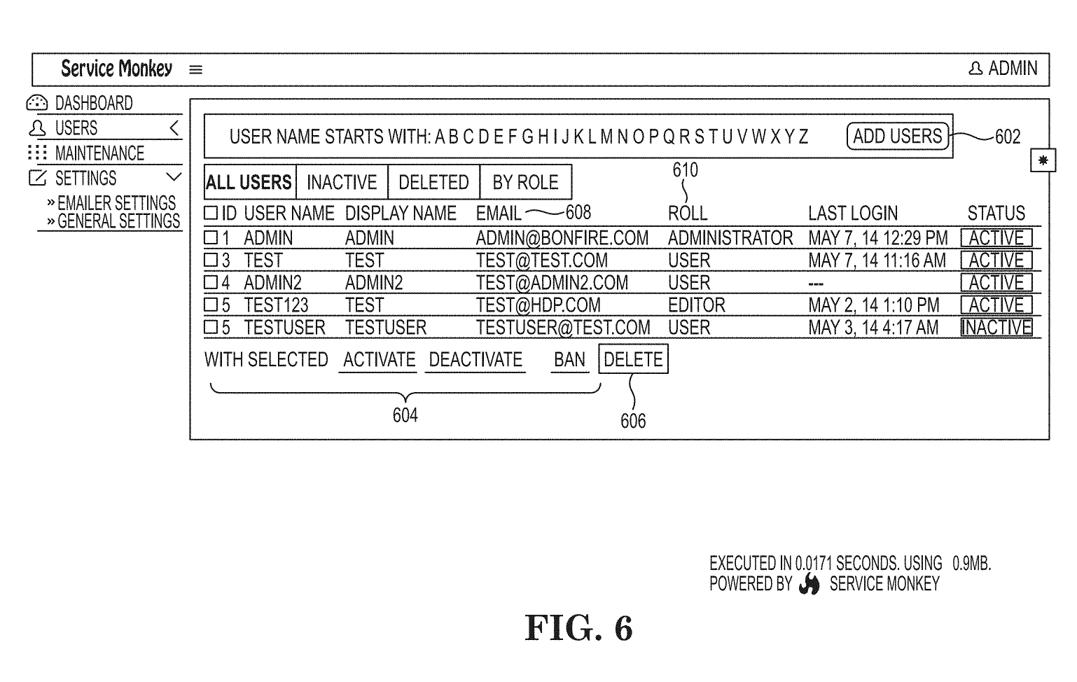

In various embodiments, the communication tool may use email for communication between a particular user, user company, service provider, backend administrator, and/or the system. In one embodiment, using an email settings interface as seen in FIG. 5, a system email address 502 may be assigned, which may be used to send all system-generated emails. In various embodiments, a system based email may also or alternatively be assigned to each user of the system. Traditional email settings selection 504 and the ability to test 506 the email may be provided. In other embodiments, a user may input an existing email which may be used to send and/or receive any communication via the system. A user may select one or more persons to send an email communication. For example, a user requesting service may select a service provider depending on location, the service requested, cost, priority level etc. A user may select one or more service providers to send the request. For example, a user may wish to send an estimate request to multiple service providers in order to get the best price. Any request email may automatically be populated with the location or address of the service to be provided. In this regard, a user requesting service may manually include the location or the application may automatically include the location using, for example, the location identifier module, discussed herein. An email to a service provider may automatically generate a copy that is sent to the backend module or other server or part of the system 100, which may be kept for file history, tracking, or otherwise. Any further communication between the service provider and the requesting user may also be done by email via the system, in some embodiments. As seen in FIG. 6, email addresses 608 (and users) may be added 602, modified 604, or deleted 606. A user's role 610 may also be added 602, modified 604, or deleted 606. While email has been described as one method that communications of a system 100 may be delivered, it is understood that any suitable communication method may additionally or alternatively be used. For example, and example only, text message communication may be used in another embodiment.

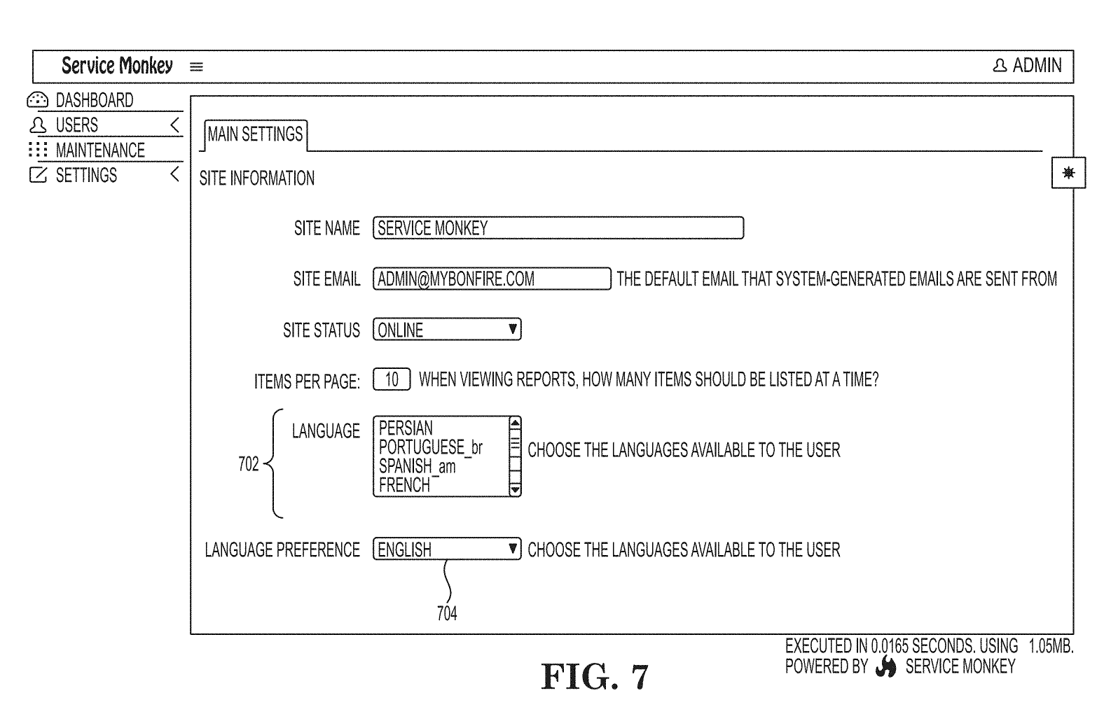

In one embodiment, the backend module of the system may automatically translate the information submitted by a user from one language to one or more other languages before transmitting the information to another user, such as an administrator of the system or backend module, or a service provider. By having multilingual capabilities, the application may be used effectively and efficiently by users who speak different languages. For example, hotel staff that do not communicate in English may still document a service request using photos, videos, audio, and/or text. Service requests documented in, for example Spanish, may be translated to English, or any other language, before being sent to an administrator of the system or backend module or a service provider. In some embodiments, the hardware and/or software components of the backend module may include translation processing hardware and/or software components to assist in translation of any text and audio files. As seen in the embodiment of FIG. 7, an administrator of the system or backend module may pre-indicate one or more languages available to users 702. For example, if users of the system, collectively, spoke English, Spanish, and French, then each language may be selected. A language preference 704 may also be indicated. Information may be displayed in the backend module using the one or more languages selected in the language preference 704. One or more language preferences 704 may be selected, for example, and example only, English. In this regard, users who speak English, Spanish, and/or French may submit a service request in any language they choose, but the system may translate the request, if warranted, and present any service request information in English on the backend module. Any system generated communication may be transmitted and/or translated into a language the user indicates is available to them. Automatically translating the requests for service, estimates, and/or service work may, however, be done in any manner known in the art, and no particular method of translating is particular to the system and method of the present disclosure. In another embodiment, an administrator may manually translate any communication between users.

In still further embodiments, the various embodiments of the present disclosure may be configured to generate and/or maintain a history log and/or file for managing the service request (also referred to herein as service log, or log). The history log and/or management file may be accessible by either the consumer or the service provider or both, providing access to all actions/events and documents occurring or developed throughout the service. In other embodiments, however, some actions/events and/or documents may be limited to access by just one party (e.g., the consumer) while other actions/events and/or documents may be limited to access by just the other party (e.g., the service provider). The history log and/or management file may contain any suitable information, including but not limited to, a list of all events occurring during performance of the service and any relevant location information, photos, videos, written descriptions or memos, work orders, and/or invoices relating to the service request and/or performance of the service.

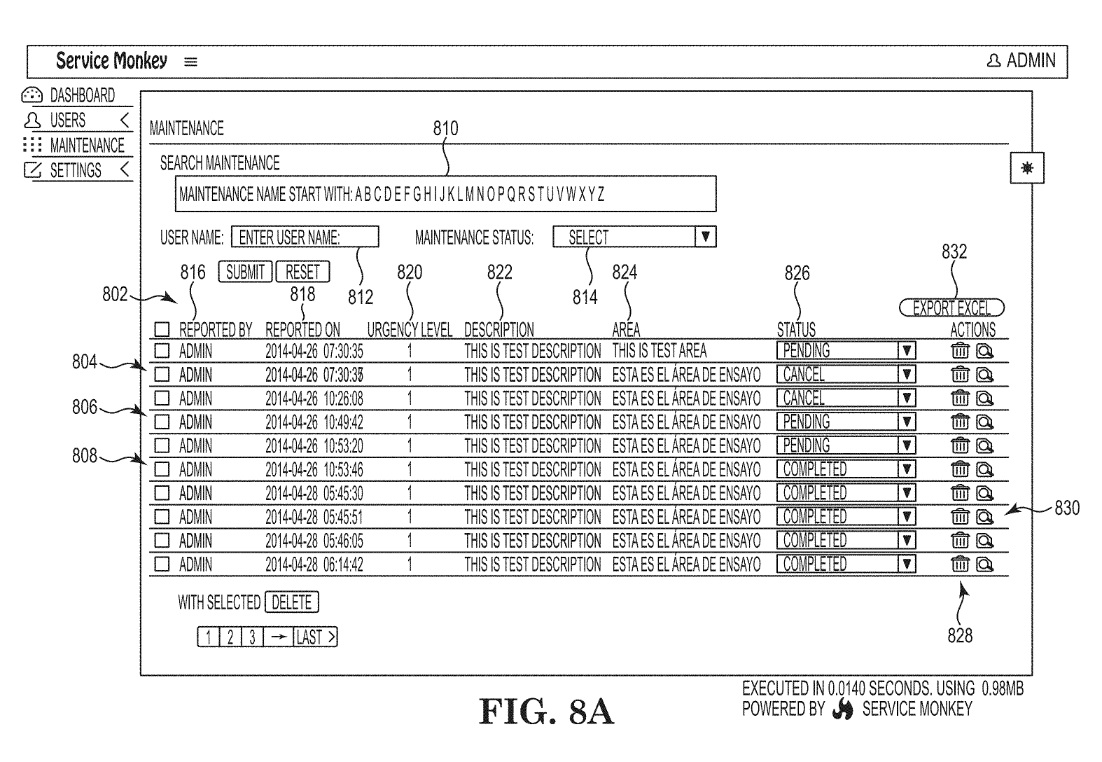

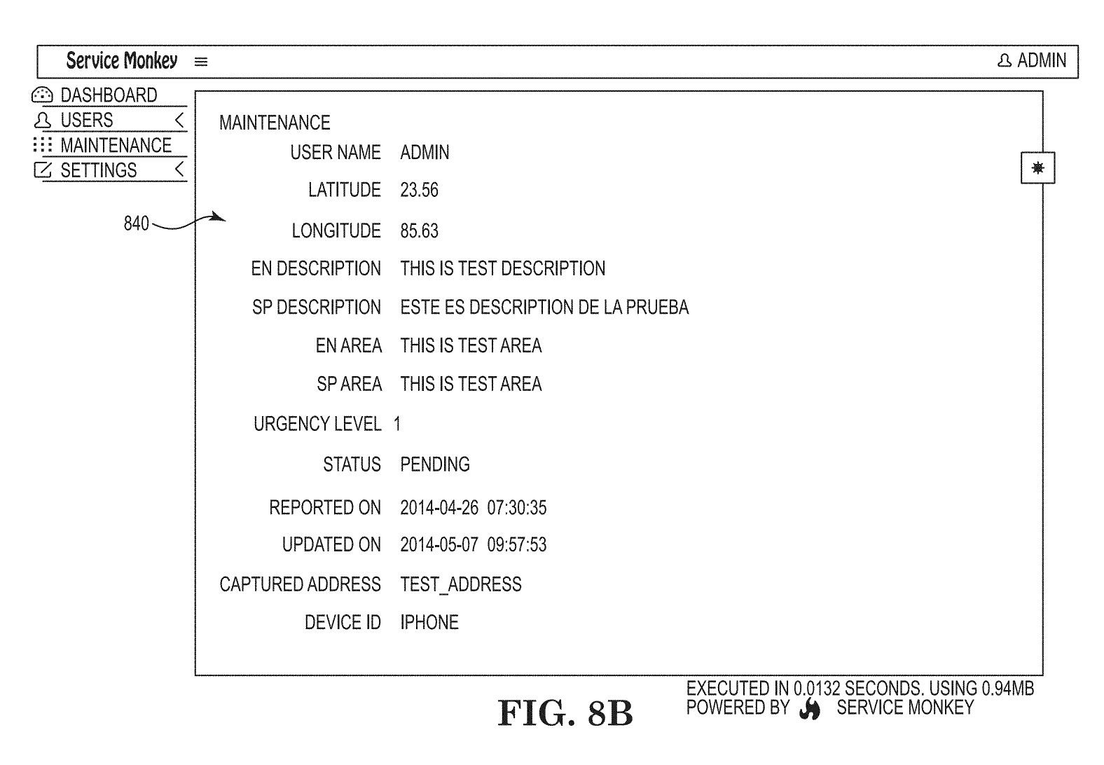

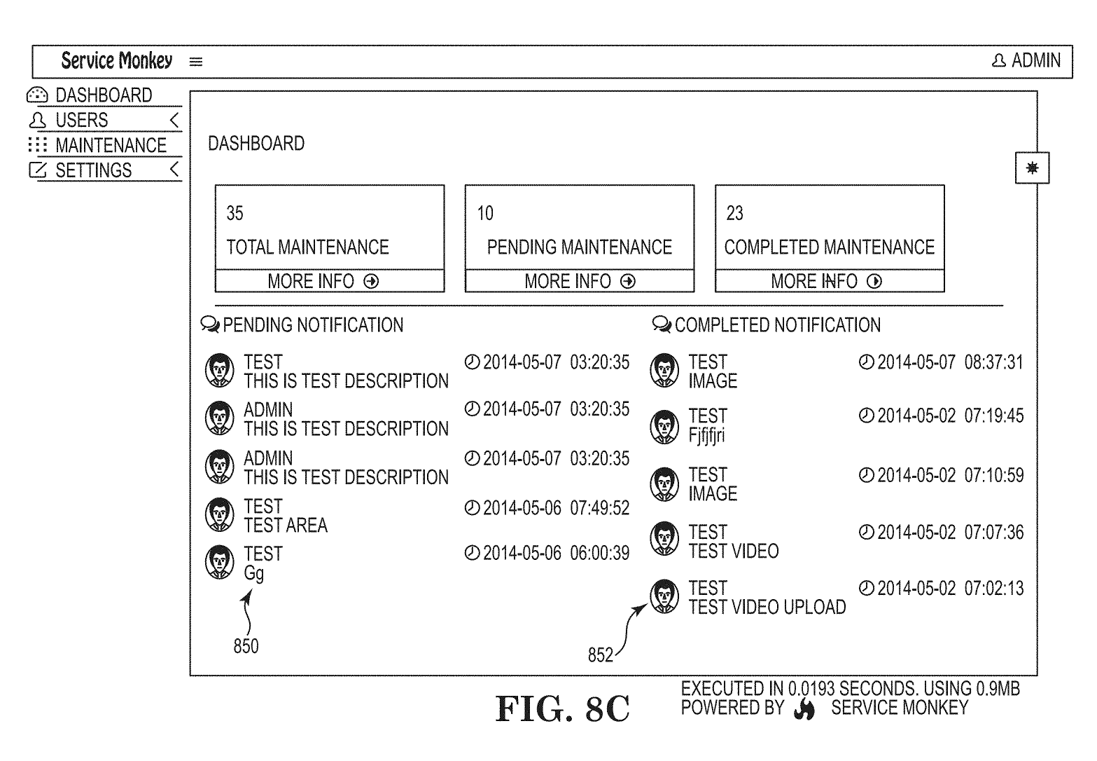

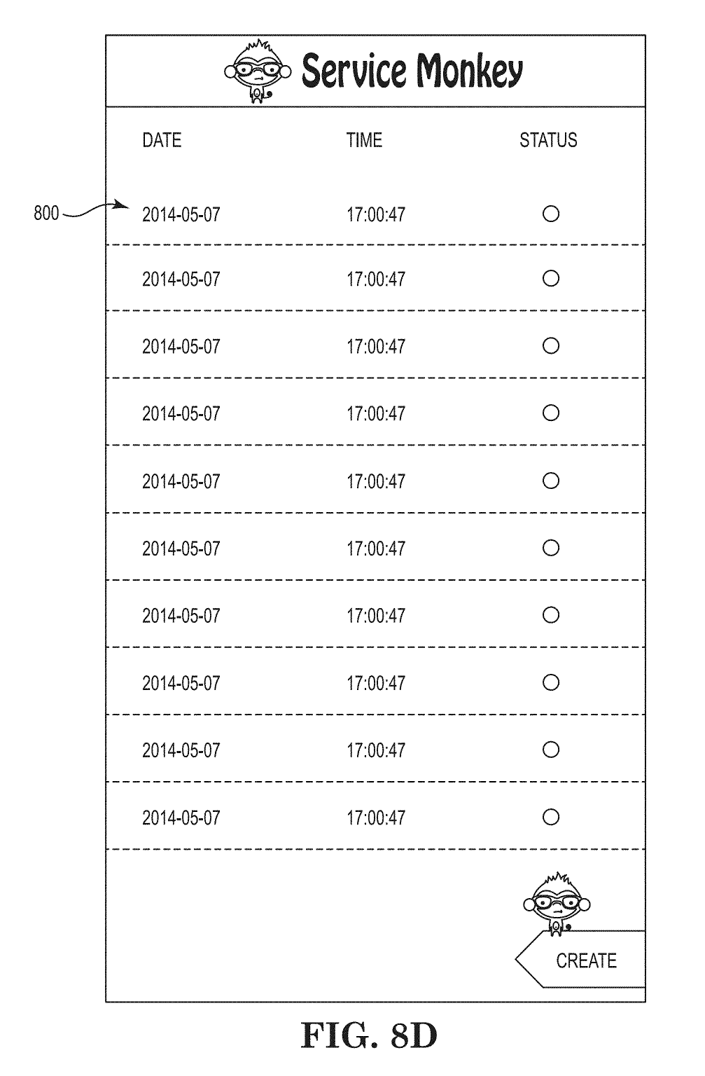

Referencing FIG. 8A, a log 802 for managing the service requests may include a list of requests, e.g., 804, 806, 808. The log 802 may be searchable by a user's first initial 810, a user name 812, the maintenance status 814, any other suitable method, or any combination thereof. Each service request may display one or more request information fields including, who reported (or submitted) 816 the request, when it was reported 818, the urgency or priority level 820, a description 822, a location 824, and a status 826. In some embodiments, selecting an information field may display more information. For example, by selecting the description, more information including further text, pictures, video, audio, or other may be seen or heard. The status 826 of the request may be changed manually, by the user of the system, or automatically as information is received by the system. A request may be removed or deleted 828 from the log 802. Individual service requests may also be viewed by selecting an icon 830. For example, as seen in FIG. 8B, a service request may be viewed individually as a service request file 840. The service request file may show relevant request information for one or more requests. In some embodiments, the service request file 840 may include the one or more pictures, videos, audio files, and text descriptions. In some embodiments, a map may be used to indicate the location. Other projects relating to the user may also be displayed. In various embodiments, the log 802 and/or service request file 840 may be tailored to display information relevant to each user. For example, the log for an administrator may display all service requests communicated through the system 100 within a predetermined time period. As seen in FIG. 8C, a log for a service provider or user requesting service, for example, may display a list of pending 850 and completed 852 logs. In some embodiments, a log for a service provider may display only those service requests sent to that provider. However, the various embodiments of the present disclosure are not so limited. As seen in FIG. 8D, a simplified service log 860 may also be used particularly, for example, for easier viewing on a mobile device.

In some embodiments, the system may include or be tied in with an invoicing or accounting system to provide the system with the capabilities for invoicing and invoice management. As seen in FIG. 8A, one or more service requests in the log 802 may be selected and then exported to excel 832. In other embodiments, all data may be automatically exported to a spreadsheet or any other accounting or recording method. In various embodiments, all data may be transmitted through the app to the server where it may populate in a spreadsheet. In some embodiment, a spreadsheet may have sorting capabilities to sort and display all information received. For example, a spreadsheet may sort out the user requesting service, the service type and description, the area or location of service, any attached files, contact information, language preferences, relevant request dates, costs, and any other relevant information. One or more spreadsheets may be populated with the data. For example, one spreadsheet may include information from all service requests while other spreadsheets include information referencing one or more requesting users, one or more service providers, and any combination thereof.

The system may also be customizable, in some embodiments, for a particular user, user company, service provider, or groups thereof. For example, a backend user or service provider may use the system to display or generate information unique to that user's needs and requirement. For example, a user may customize the system to generate special reports. In one embodiment, a service provider may customize a monthly invoice report for each individual client. The invoice may be printed and mailed, emailed using the system, or transmitted by any other suitable method. In another embodiment, a backend user may generate a monthly and/or annual report showing the breakdown, or categorization, of the service requests. The breakdown may show the number and/or percent of overall requests that relate to an industry, for example hotels or automotive. The breakdown may show information relative to a service type, for example plumbing or construction. The breakdown may also show information relating to the average cost of each request, as a total average or by category, for example.

Payment may also be facilitated by the system, in some embodiments. For example, in some embodiments, a user requesting service may, or may even be required to, load credit card information, paypal information, or some other payment method before requesting a service. Upon completion and confirmation of the service provided, the system may debit the user requesting service's account and credit the service provider's account, as warranted. It is understood by those in the art than any suitable payment method implementation may be used.

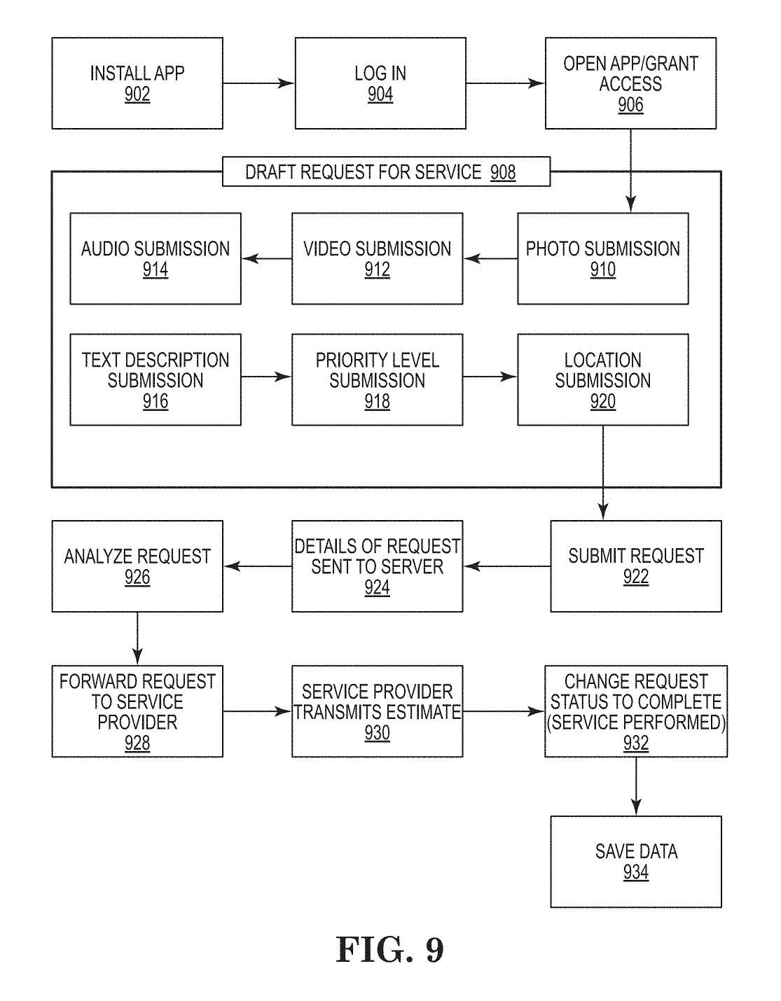

Having described the system, a method 900 of use is provided below. Generally, and in reference to FIG. 9, a consumer may install an application or app 902 in accordance with the present disclosure. The user may then log in 904, which may, but need not, require the first time user set-up described above. After providing sufficient log in information 904 the application may open, or grant access, 906 for the user to use the app. A user may access the system to draft a request for service 908. As described above, the service desired or requested may relate to any type of service, and is not limited to any service example provided herein. However, in some embodiments, the type of service desired or requested may be a request for repair(s), cleaning, or other maintenance, for restocking inventory or other inventory services, or any other property management or store management service(s). The consumer may access 906 the system to draft a request for service 908, in some embodiments, via a web-based application or a mobile app operating on a mobile device with access to a communications network, such as but not limited to a telephone network, wireless network, LAN, or WAN, such as the Internet. The consumer may draft the request for service 908 via the request interface and accompanying interfaces, described in detail above. Generally, a consumer's request for service 908 may include one or more of the following: one or more photos 910, and/or one or more videos 912, and/or one or more audio files 914, and/or one or more written descriptions 916, each of which may provide information relating to the service needed or desired. The user may then request a priority level 918 indicating how quickly the service should be started, completed, or both. A location for the service requested may be submitted 920, either manually by the user or automatically by the location identifier module. Once the appropriate request for service has been prepared, the consumer may submit the request 922, which causes the request, along with any associated information, to be transmitted to a backend module, or server, 924.

As discussed above, the information may be analyzed 926, automatically or manually. In some embodiments, the request for service may be analyzed 926 to determine, possibly among other things, the appropriate work to be performed and/or the service provider representative(s) or contractor(s) needed and may forward the information, along with any additional information that may be deemed suitable by the backend module and/or the service provider, to the identified service provider representative(s) or contractor(s) 928. In one embodiment, the user may select the one or more service providers to send the service request. In another embodiment, the system or an administrator or other suitable user thereof selects one or more suitable service providers based on the analysis 926. The service provider may comply with the request by providing an estimate 930 for service and/or performing the service thereby completing the request 932, whichever may be the case. The consumer and service provider may further continue communications via the system, such as through communications between the web-based application or mobile app operating on the consumer's mobile device and the backend module operated by the service provider. The system may track the progress and indicate the request as pending, in-progress, or completed 932, whichever the case may be. The service provider may use the application to document progress, for example, the service provider may take one or more pictures, one or more videos, one or more audio files, and/or one or more text comments as warranted and submit them to the system. For example, the service provider may submit one or more “before,” “in-progress,” and “completed” pictures to indicate status of the progress. In one embodiment, all, or any sub-portion of, communication can be saved on the backend module 934 for later viewing.

As indicated above, the system may be used by a consumer to initiate a request for service. The service desired or requested may relate to any type of service, which in some embodiments, may be for repair(s), cleaning, or other maintenance, for restocking inventory or other inventory services, or any other property management or store management service(s). In this regard, the system can be easily configured for application in a variety of specific industries, including:
Hospitality industry, including for example, the restaurant and hotel industries, wherein the various embodiments of the present disclosure may be utilized by restaurant or hotel staff, as consumers, to request service at any particular restaurant or hotel location. Such services may be, for example, for repair(s), cleaning, or other maintenance, for restocking inventory or other inventory services, etc., as described above. However, the present disclosure is not so limited.
The service provider may be a third-party service provider offering the requested services. In other embodiments, however, the service provider may be, for example, a particular hotel or restaurant employee branch or one or more particular employees of the hotel or restaurant whose responsibility is to provide the requested services. In this regard, in some embodiments, the system of the present disclosure may be an entirely internal system, being fully operated by a single entity or multiple related entities.
Housing industry, wherein the various embodiments of the present disclosure may be utilized to request and/or manage services required by various residential properties, typically under the management by a property management company. Such services may be, for example, for repair(s), cleaning, construction, or other maintenance, etc., as described above. However, the present disclosure is not so limited.
Again, the service provider may be a third-party service provider offering the requested services. In other embodiments, however, the service provider may be a particular employee branch or one or more particular employees of the property management company whose responsibility is to provide the requested services. In this regard, in some embodiments, the system of the present disclosure may be an entirely internal system, being fully operated by a single entity or multiple related entities.
Industrial, Commercial, or Government Agencies, wherein, similar to the industries above, the various embodiments of the present disclosure may be utilized to request service at any particular industrial, commercial or government-run facility. Such services may be, for example, for repair(s), cleaning, or other maintenance, for restocking inventory or other inventory services, etc., as described above. However, the present disclosure is not so limited.
Again, the service provider may be a third-party service provider offering the requested services. In other embodiments, however, the service provider may be, for example, a particular employee branch or one or more particular employees of the same company as the requesting consumers whose responsibility is to provide the requested services. In this regard, in some embodiments, the system of the present disclosure may be an entirely internal system, being fully operated by a single entity or multiple related entities.

In general, however, the system can be easily configured for application in a variety of further industries in a similar manner, including use by, but not limited to, a variety of types of property management firms, general contractors, airports, grocery or retail chains or other multi-location entities, sports arenas, and generally any facility that has a need for service to structure or equipment. The various embodiments of the present disclosure are not intended to be limited solely to those industries or applications specifically called out herein, which are provided only as examples.

In general, the various embodiments of the present disclosure may permit a user to make requests for service or estimate for service (often collectively referred to herein as a “request for service” for ease of explanation), such as but not limited to, requests for repair, maintenance, or restocking, or estimates therefor, through a mobile device, and specifically via a web-based application or mobile app. The application or app may permit the user of the mobile device to provide and send a description or other details or information relating to the request for services to a service provider in an efficient manner, and which may include photographs, videos, and/or audio relating to the requested services. The mobile device may communicate over a network, such as but not limited to, a telephone network, wireless network, LAN, or WAN, such as the Internet, with a backend module, to which the request and related information may be delivered and reviewed, automatically or manually, to determine what the request for service entails. In some embodiments, the mobile device and backend module may be owned and/or operated by the same entity while in other embodiments, the mobile device and backend module may be owned and/or operated by different entities. In some embodiments, appropriate resources can be deployed or diverted to the location whereat the services are to be performed, depending on, for example, the urgency of the request. In still further embodiments, the application or app may permit a user of the mobile device to track and/or manage various aspects of overall service performed per the request, such as but not limited to, status, invoicing, service technician information, etc.

Advantages of the various embodiments of the present disclosure include but are not limited to, increased efficiency resulting in a savings in labor costs and expedited services, the ability to be used by consumers in multiple locations with world-wide substantially “real-time” response, and quick setup with minimal to no training for consumers. The various embodiments of the present disclosure may be configured for stand-alone operation in a local, regional, state, national, or international business ecosystem. Other advantages will be recognized by those skilled in the art, and some advantages may be particular to a specific industry.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A system for service request submission and management, the system comprising a software interface module for downloading to an electronic mobile device and operating as a mobile app for display on a display screen of the electronic mobile device, the interface module further:
receiving information identifying a user of the electronic mobile device initiating a request for a service or an estimate for service;
receiving information relating to the request for a service or an estimate for service, the information including at least one of written text, a photo, a video, and an audio file, and identifying the location where such service is to be completed;
upon activation by a user, transmitting the information relating to the request to a remotely located backend module, comprising at least one of hardware and software, to assign a corresponding service provider to the request for service or estimate for service; and
coordinating communication subsequent the initial request for service or estimate for service between the user and the assigned service provider and providing access to a history log thereof.

2. A method for receiving a request for a service and for providing services based on the request, the method comprising:
providing a software interface module for downloading to an electronic mobile device and operating as a mobile app for display on a display screen of the electronic mobile device;
receiving, via the interface module, information identifying a user of the electronic mobile device initiating a request for a service; receiving, via the interface module, information relating to the request for a service, the information including at least one of written text, a photo, a video, and an audio file, and identifying the location where such service is to be completed;
upon activation by a user, transmitting the information relating to the request to a remotely located backend module;
parsing and analyzing the transmitted information relating to the request to assign a corresponding service provider to the request for service; and
managing communication subsequent the initial request for service between the user and the assigned service provider and maintaining a history log thereof.

3. The method of claim 2, wherein parsing and analyzing the transmitted information relating to the request to assign a corresponding service provider comprises determining the work to be performed and at least one person with the appropriate skill set to complete the work to be performed.

4. The system of claim 1, wherein the location where such service is to be completed is automatically obtained from positional information determined by the electronic mobile device.

5. The system of claim 1, wherein the information relating to a request for a service or an estimate for service comprises a photo, and the interface module provides the user in-app photo-taking capability without having to leave the interface module.

6. The system of claim 1, wherein the interface module further receives information relating to the priority or urgency of the request for service or estimate for service.

7. The system of claim 1, wherein the user and assigned service provider are employees of the same entity.

8. The system of claim 1, wherein the interface module further receives information relating to one or more service providers desired by the user for completing the service or estimate for service.

9. The method of claim 3, further comprising dispatching the at least one person to the location of the work to be performed.

10. The method of claim 9, further comprising obtaining the location where such service is to be completed automatically from positional information determined by the electronic mobile device.

11. The method of claim 10, wherein the information relating to a request for a service comprises a photo, and the interface module receives the photo via in-app photo-taking capability of the interface module.

12. The method of claim 10, further comprising receiving, via the interface module, information relating to the priority or urgency of the request for service.

13. The method of claim 3, wherein the user and assigned service provider are employees of the same entity.

14. The method of claim 2, further comprising receiving, via the interface module, information relating to one or more service providers desired by the user for completing the service.
